(19) United States
(12) Patent Application Publication
(10) Pub. No.: US 2003/0194046 A1
(43) Pub. Date: Oct. 16, 2003

(54) Method for period counting using a tunable oscillator

(76) Inventor: Jerry Lester Shirar, Hanover Park, IL (US)

Correspondence Address: PATENT DOCKET DEPARTMENT, GARDNER CARTON & DOUGLAS LLC, 191 N. WACKER DRIVE, SUITE 3700, CHICAGO, IL, 60606, US

(21) Appl. No.: 10/122,441

(22) Filed: Apr. 11, 2002

(51) Int. Cl. G01D 1/00

(52) U.S. Cl. 377/19

(57) ABSTRACT

A method and system for improved accuracy in period counting using a tunable oscillator, such as a voltage controlled oscillator, without an additional reference oscillator. The method and system use digital logic to correct the count made by a counter by loading the counter with a preset. The invention is suitable for use with any digital circuit that has a tunable oscillator and programmable digital logic.

### FIELD OF THE INVENTION

The invention generally relates to the use of digital electronics to accurately produce and measure the period or frequency of an electrical signal. More specifically, the invention relates to a method and system for period counting using a tunable oscillator without an additional reference oscillator.

### BACKGROUND OF THE INVENTION

Electronic circuits may sometimes require the use of a very stable and accurate electronic oscillator in order to measure the period or frequency. Period counting (or, equivalently, frequency measurement) is necessary for providing very accurate timing or phase locking in a feedback loop. Oscillators are used for other applications, such as for transmitting and receiving an electronic signal or for producing an accurate waveform, but these applications do not always require a high degree of stability and accuracy.

Typically, an electronic circuit designed for an application that requires a stable and accurate oscillator will use a Quartz crystal oscillator as a reference oscillator. In its crystalline form, Quartz exhibits the special property of piezoelectricity: when pressure is applied to a Quartz crystal, there will be a change in an electrical voltage that is measured at the surface of the Quartz crystal. Conversely, an applied electric voltage may cause the Quartz crystal to physically deform. When a Quartz crystal is cut and polished, it will vibrate at a single specific frequency as an electric field is applied through electrical contacts plated onto its surface.

The electrical oscillation produced by a vibrating Quartz crystal has a very high quality factor (also called a “Q factor”), meaning that its oscillations are very pure in frequency. The stability of the oscillations over time is a mathematical consequence of purity in frequency. For these reasons, a Quartz crystal oscillator is almost invariably used when a stable reference oscillator is necessary.

There are oscillators more stable and accurate than the Quartz crystal oscillator, but these oscillators, such as a Cesium 133 atomic oscillator (also known as an “atomic clock”), are very expensive and difficult to implement. Sometimes an atomic oscillator may even require auxiliary Quartz crystal oscillators in order to be properly implemented.

Disadvantages to the use of a Quartz crystal oscillator as a reference oscillator are relatively high cost and large size. The designer of an electronic circuit seeks to minimize the number of components used to perform a particular function, such as period counting, in order to lower the cost of mass producing the electronic circuit. In addition, after the most critical components for a design have been placed on a circuit board, there may be little or no space left for a Quartz crystal oscillator, which is bulky relative to other types of electronic components. The presence of an oscillator with a frequency different from that of the other electrical signals in a circuit also presents a disadvantage, as it may give rise to electromagnetic interference (EMI) unless special design measures are taken.

When specifications for the accuracy of the reference oscillator permit, it may be possible to substitute a smaller, cheaper, and less stable reference oscillator, for example, an RC or LC circuit for a Quartz crystal reference oscillator. Usually, this solution is not available for applications in which the accuracy and stability of a reference oscillator may not range beyond a certain threshold. In addition, any other oscillator that must be added to the circuit simply to be used as a reference suffers from the same disadvantages listed above for Quartz crystal oscillators.

A need, therefore, exists for an accurate reference oscillator that does not require an additional Quartz crystal reference oscillator, or other type of additional reference oscillator. These and other advantages of the invention, as well as additional inventive features, will be apparent from the description of the invention provided herein.

### BRIEF SUMMARY OF THE INVENTION

The present invention provides a method and system for using a tunable oscillator for period counting without an additional reference oscillator. The method and system of the present invention provide a great advantage to a designer of an electronic circuit that might already have a tunable oscillator, such as a voltage controlled oscillator, in his or her electronic circuit design because it eliminates the need for an additional reference oscillator to be included.

The apparatus of the present invention in brief might be referred to as a period counter, although the present invention is capable of measuring either period or frequency, which have a simple algebraic relationship. The period counter of the present invention is used for measuring a DUT signal using a tunable oscillator without using an additional reference oscillator. For the period counter to operate, it requires a digital input which is used for two purposes within the system and method of the present invention: (1) for a preload to the counter after being scaled by a sequence of digital logic that includes an inverter, multiplier and divider; and (2) for input to the voltage controlled oscillator, after being converted to an analog voltage with a DAC.

The sequence of digital logic that is used to invert, multiply, divide, and optionally to subtract from the digital input might not appear as a set of four separate components in some embodiments of the present invention. The multiplier and divider, for example, might be combined if programmable digital logic is available that allows for fractional multiplication. In a different embodiment of the invention, the digital logic used to subtract a value from the digital input might not be used if the digital input does not need to be corrected.

As is known to those of ordinary skill in the art of the present invention, the American National Standards Institute (ANSI) has developed standards, known as the stratum I, II, III, and IV standards, which may be used to rate the accuracy of an oscillator. The present invention has been implemented within a stratum III timing module, in which there is only one oscillator available for all functions. According to the current ANSI standard, a stratum III timing device must provide a frequency stable to within 4.6 parts per million (or “ppm”, a value equivalent to 0.00046%) of its frequency in Hertz, with a drift in average frequency less than 0.37 ppm over a 24 hour period.

One embodiment of the present invention provides a stratum III accuracy measurement of an input 8 kHz input signal frequency of stratum III accuracy, using only a voltage controlled oscillator, which is not by itself of stratum III accuracy, and may have an accuracy as low as ±15 ppm (or ±0.0015%), without an additional reference oscillator. This accuracy corresponds to the tuning voltage accuracy of the voltage controlled oscillator. The accuracy of a tunable oscillator is sometimes given in terms of a tuning voltage to frequency ratio, which is smaller (±4.6 ppm).

In accordance with another embodiment of the present invention, a voltage controlled crystal oscillator (“VCXO”) is included in a stratum III timing device, and is used in a phase locked loop. It is not essential to the present invention, however, that a phase locked loop be present. The VCXO, or a VCO, might be included in a different design for some other reason, for example, for use as a waveform generator, transmitter, or receiver. An important aspect of the present invention is that it makes use of the VCXO or VCO that is already present on the board and uses it as a reference oscillator so that an additional reference oscillator is unnecessary.

In other embodiments of the present invention, there is provided a stratum III accuracy measurement of an input stratum III signal frequency in a relatively short amount of time. It is well known to those of ordinary skill in the art that the accuracy of a frequency measurement can be improved by prolonging the amount of time allowed for the measurement of that frequency. For low frequencies, however, the time needed to reach a high level of accuracy may be years. In an embodiment of the present invention, accurate frequency measurements are made in a relatively short amount of time by using a period counting configuration in which the signal from the device under test is used to gate the clock frequency.

In yet another embodiment, the method of the present invention relies on the output of a digital-to-analog converter (DAC) as the input for a voltage controlled oscillator. As described above, the input of a DAC is a digital input within a certain range of digital input; its output is an analog voltage within a range that corresponds to the input range of digital numbers. According to the present invention, the output voltage of the DAC serves as the input voltage for a voltage controlled oscillator; the digital input to the DAC serves also (after processing by an inverter, multiplier, divider, and subtracter) as an input preset for a counter within the system of the present invention. It is this preset for the counter that allows for the lower accuracy of lower frequencies within the frequency range of the voltage controlled oscillator to be corrected, producing a frequency measurement more accurate than has been possible in the past without an additional reference oscillator. In accordance with an embodiment of the present invention, the correction to the voltage controlled oscillator provided by the preset to the counter allows for a stratum III accuracy measurement of an input signal period (and hence frequency).

### BRIEF DESCRIPTION OF THE DRAWINGS

The foregoing and other objects, advantages, and features of the present invention will be apparent from the following detailed description and the accompanying drawings, in which:

FIG. 1 is a block diagram showing prior art in period counting, and the use of a Quartz crystal as reference oscillator; and

FIG. 2 is a block diagram of the electronic components of the improved system for period counting, in accordance with an embodiment of the present invention.

### DETAILED DESCRIPTION OF THE INVENTION

While the present invention is susceptible to various modifications and alternative forms, certain preferred embodiments are shown by way of example in the drawings and will be described in detail herein. It should be understood, however, that the description is not intended to limit the invention to the particular forms described; to the contrary, the description is intended to cover all modifications, alternatives, and equivalents falling within the spirit and scope of the invention defined by the appended claims.

As mentioned above, it is known to those of ordinary skill in the art that the accuracy and speed of low frequency measurements may be improved by counting the period of the signal rather than its frequency. It is easy to find the frequency of a signal once its period is known: the frequency is simply the inverse of the period (period=1/frequency). For the following discussion of the related art, it may be helpful to refer to the following text: Horowitz, P. The Art of Electronics, N.Y., Cambridge University Press, 2001, p. 1019-1022.

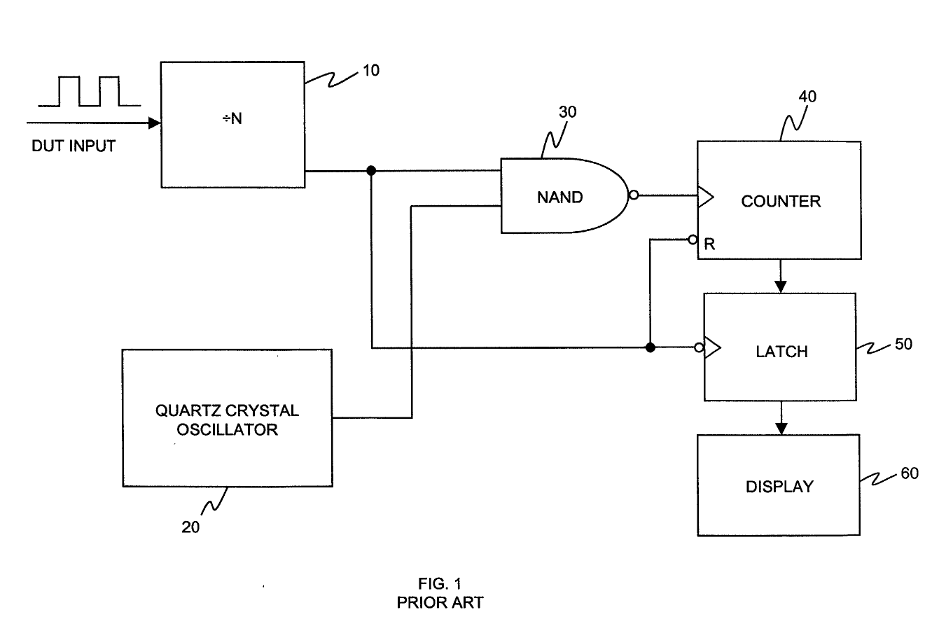

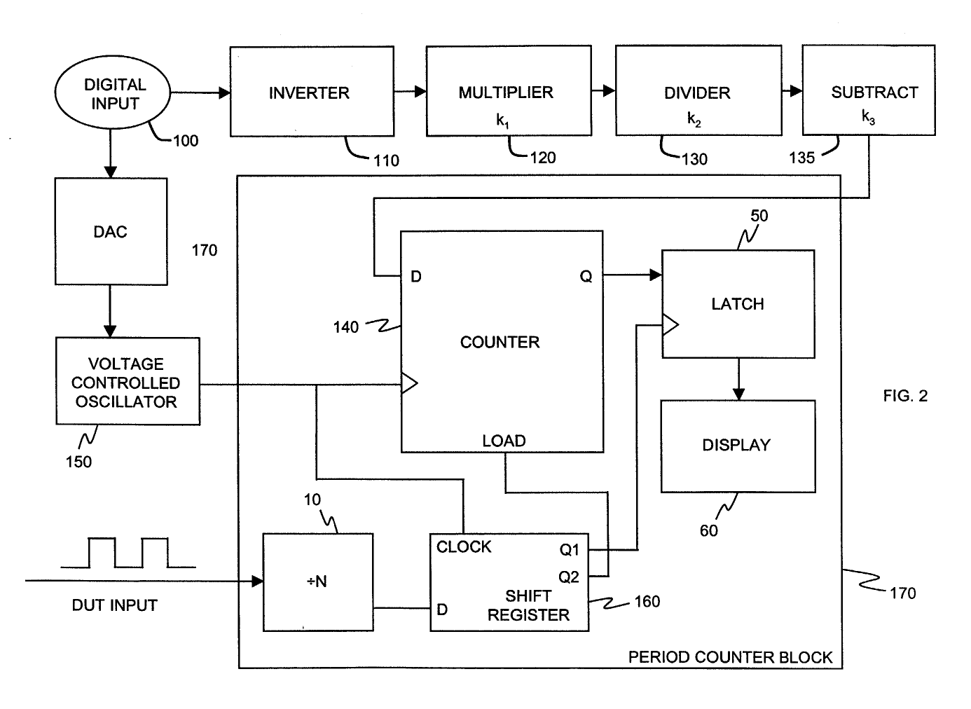

Referring to FIG. 1, there is shown a block diagram of the prior art in period counting with a Quartz crystal reference oscillator. The input signal to be measured is shown in FIG. 1 and FIG. 2 as originating with a device under test (or “DUT”). An N-divider 10, which might be constructed from one or more flip-flops or from programmable digital logic, is used to increase the length of the period of the input signal by a factor N. In an embodiment, the factor N might be selected by a user, for example, with a switch. With the reference frequency for the period counter fixed, increasing the factor N increases the length of the measurement time and increases the resolution of the measurement; decreasing the factor N decreases the length of the measurement time and decreases the resolution of the measurement. In this manner, a user of this system may balance the desired accuracy for his or her measurement with the amount of time necessary for the measurement to be completed.

The output of the N-divider 10 is fed into one input of a NAND gate 30, a reset (labeled “R”) for a counter 40, and a latch 50. As is known to those of ordinary skill in the art, the wedge shown at the input for both the counter 40 and the latch 50 indicates that these devices are edge-triggered, i.e., that the rising edge of an input pulse will activate these devices. Furthermore, it is well known to those of ordinary skill in the art that a small circle at an input or output to a device indicates a negation; the wedge with the small circle, therefore, indicates that the device is negative edge-triggered.

As shown in FIG. 1, a Quartz crystal reference oscillator 20 is the second input to the NAND gate 30. As described above, it is not necessary that the reference oscillator 20 be a Quartz crystal reference oscillator; it may be any non-tunable reference oscillator. A “non-tunable” reference oscillator might include, for example, an oscillator that allows for its frequency accuracy to be adjusted on an occasional basis. The tunable voltage controlled oscillator of the present invention is distinguished from other non-tunable oscillators in that it allows for tuning to take place during normal operation; the tunable oscillator of the present invention may be called an “agile-tunable” oscillator for this reason.

With an electronic circuit in the arrangement shown in FIG. 1, the frequency of an input signal from a DUT is counted with the counter 40, and on the falling edge of the DUT's signal, the count from the counter 40 is latched to the latch 50, and the counter is reset. The latched count is then displayed with a display 60, which might be an array of light emitting diodes, a liquid crystal display, or some other display capable of displaying a number or value.

A voltage controlled oscillator (VCO) is used in accordance with several embodiments of the present invention. Voltage controlled oscillators are themselves an electronic circuit, which is usually built onto a small integrated circuit (IC) chip. VCO ICs are available from commercial manufacturers such as BURR-BROWN, TEXAS INSTRUMENTS, EXAR, and MOTOROLA, and may be manufactured in a variety of different ways, with both digital and analog components, and according to a variety of different specifications. One popular variety of voltage controlled oscillator is built out of a varactor diode. Another known VCO is built around a Quartz crystal oscillator. Voltage controlled oscillators that are built around a crystal oscillator are sometimes called voltage controlled crystal oscillators (or “VCXOs”). VCXOs do not usually provide the accuracy of a non-tunable Quartz crystal oscillator. Nevertheless, in the present invention a VCO is used in a novel way to improve the accuracy to the level of a more stable reference oscillator, such as a Quartz crystal oscillator. Other types of voltage controlled oscillators might be used as a tunable oscillator within the method and system of the present invention, as is known to those of ordinary skill in the art.

Usually, a voltage controlled oscillator works by converting an input voltage within an input voltage range into an output frequency within an output frequency range (the VCO frequency is “tuned” by the input voltage). In some cases, as in an embodiment of the present invention, the voltage controlled oscillator's frequency might be tuned digitally, with the output from a digital-to-analog converter (DAC). The digital input to the DAC corresponds to a specific voltage that, in turn, tunes the VCO to a specific frequency.

Referring to FIG. 2, there is shown a block diagram of the electronic circuit used for improved accuracy in period counting with a voltage controlled oscillator, in accordance with an embodiment of the present invention. The signal input from a DUT is divided with an N-divider 10 as it is input into a period counter block 170; the output of the N-divider 10 is supplied to the clock of a shift register 160.

The shift register 160 is used to avoid a logic race between the reset of the counter 140 and the latch 50, i.e., to avoid introducing a transient pulse into the system that might cause downstream logic to malfunction. In other embodiments of the present invention, another technique might be used to avoid logic races. The shift register 160 could be replaced by a simpler set of digital components, such as a NAND gate or NOR gate. It is not necessary to the present invention that a shift register be used. Using the shift register 160 shown in FIG. 2, the count is latched one clock cycle before the counter 140 is reset and loaded with a preset value. The “LOAD” shown on the counter 140 shows that the counter has the ability to be loaded with a preset count after it is reset.

According to an embodiment of the present invention, a digital input 100 is a digital number that corresponds to a particular input voltage within an input voltage range for a voltage controlled oscillator 150; the digital number might be in any format, but in a preferred embodiment of the present invention it is in binary format. The digital input 100 is converted into an analog voltage, which is supplied to the voltage controlled oscillator 150 with a digital to analog converter (DAC) 170.

An important aspect of the present invention is that the voltage controlled oscillator 150 is the only reference oscillator input to the counter 140. The only other input to the period counter block 170 is the signal from the DUT. The voltage controlled oscillator 100 is the only reference oscillator necessary for period counting with the present invention.

At the top of FIG. 2, there is shown a sequence of inverter 110, multiplier 120, and divider 130; the digital input 100 serves as input to this sequence; the output of this sequence is sent to the input for the counter 140. The sequence of inverter 110, multiplier 120, and divider 130 is used, in an embodiment, to scale the digital input 100 to a value that matches the frequency output of the voltage controlled oscillator 150 before it is input as a preset to the counter 140.

The need for the inverter 110 is understood by observing how a count might vary even with a constant DUT input frequency. The voltage controlled oscillator 150, unlike the usual reference oscillator (for example, a Quartz crystal oscillator 20), has a tunable frequency. If the digital input 100 is a digital value that corresponds to an input voltage that is high within the input voltage range for the voltage controlled oscillator 150, then the counter 140 will count up to a larger number than if the digital input 100 were a digital value that corresponded to an input voltage that were low within the input voltage range for the voltage controlled oscillator 150. Therefore, the preset for the counter 140 should be large when the digital input 100 is small, and small when the digital input 100 is large. In an embodiment of the present invention, the inverter 110 accomplishes this purpose.

The multiplier 120 and divider 130 are used to scale the preset to a value that corresponds to the period (and hence frequency) of the voltage controlled oscillator 150; they are necessary when the range and increments of the scale used for the digital input 100 is not the same as the range and increments of the scale used in measuring the period (and hence frequency) of the DUT. According to an embodiment of the present invention, the multiplier 120 multiplies the digital input 100 by a value k₁; the divider 130 divides the digital input 100 by a value k₂. The correct values for k₁ and k₂ are defined below. In other embodiments of the invention, where digital logic that can perform fractional multiplication is available, the use of a separate multiplier and divider would, of course, be unnecessary. In these embodiments, the two constants k₁ and k₂ might be replaced with a single, fractional constant k. The subtract block 135 serves to provide the scalar offset k₃ to the preset before it is loaded into the counter. The value k₃ is merely a correction factor, which allows for the preset to be calibrated. The group of inverter 110, multiplier 120, divider 130, and subtract 135 generally serve as a scalar multiplier for digital input to the period counter block 170.

In the presently preferred embodiment of the invention, the preset value loaded into the counter 140 can be found from the following equation, which may be deduced from the block diagram of the system shown in FIG. 2:

$$P = {k}_{1} ( 1 - \frac{V}{{k}_{2}} ) - {k}_{3} \qquad Equation I$$

wherein:

P is the preset value, a number loaded as a preset to the counter 140;

k₁ is the maximum error in the count, whose value is further defined below;

V is the digital input 100 that corresponds to an input voltage within the input voltage range for the voltage controlled oscillator 150;

k₂ is a digital number that corresponds to the input voltage range of the voltage controlled oscillator 150; and

k₃ is the scalar difference between the nominal DAC value, which returns a nominal frequency output from the VCXO, and the minimum with a constant reference input.

As shown in FIG. 2, the multiplier 120 and divider 130 accomplish the multiplying of the input by k₁ and dividing of the input by k₂. The minus sign that appears in Equation I is accomplished, according to an embodiment of the present invention, by the inverter 110.

The value of the maximum error in the count k₁ is defined by the following equation:

$${k}_{1} = 2 ( \frac{{f}_{ref}}{{f}_{DUT}} ) Δ F \qquad Equation II$$

wherein:

k₁ is the maximum error in the count;

f_{DUT} is the mean frequency of the N-divided frequency of the DUT;

f_{ref} is the mean frequency of the voltage controlled oscillator 150 at zero input voltage; and

ΔF is the error in the frequency of the voltage controlled oscillator 150.

It is important to note that the factor of two shown in Equation II, which may be included in a manufacturer's specification for ΔF, is meant to refer to the half-width of the frequency range for error within which a voltage controlled oscillator 150 might be found. Sometimes, this value may be reported as the full width of the range for error around some mean frequency, which in this case is chosen as the mean frequency of the voltage controlled oscillator 150 with zero input voltage.

An example of how the system of the present invention works with specific values for the variables defined in Equations I and II is presented herewith. Assume that in one embodiment of the present invention the value of ΔF for a particular voltage controlled oscillator is ±15 ppm (or 0.0015%). Assume also that in this embodiment of the invention f_{ref}, the mean frequency of the voltage controlled oscillator, is 19.44 MHz. Further assume that in this embodiment the mean frequency of the input signal of the DUT is 8 kHz, and that the N-divider is a 1215-divider. All of these values would be readily known to one of ordinary skill in the art who sought to make and use the present invention from the specifications for the components used in making the invention. From Equation II it is clear that the value of k₁ for this system is 88.6.

If this value for k₁ is used in Equation I, a set of values for the preset P for the counter 140 may be found. Assume that in this same embodiment the magnitude of k₂ corresponds to an input voltage range for the voltage controlled oscillator (the same voltage controlled oscillator whose f_{ref} and ΔF were used in finding k₁, above) of 4.095 Volts, as is typical for a voltage controlled oscillator designed for use with digital electronics.

If the digital input 100 corresponds to a voltage in the middle of this range, then the value of V might be 2.048 Volts; the preset P, therefore, would be 44.3 or about 44 counts.

If the digital input 100 corresponds to a voltage in the low part of the input voltage range, then the value of V might be 1.024 Volts; the preset P would become 66.

If the digital input 100 corresponds to a voltage in the high part of the input voltage range, then the value of V might be 3.072 Volts; the preset P would become 22.

Similarly, if the digital input 100 corresponds to the maximum voltage, the preset would become 0; if the digital input 100 corresponds to the minimum voltage, the preset would be 88.6.

The factor k₃ is picked to correct for variations in the value of the nominal frequency of the voltage controlled oscillator, in order to make the displayed count value correspond to a real frequency (rather than an a number that is linearly offset from the real frequency). For example, if the nominal frequency has a DAC value of 2048 (base 10), and a 12 bit counter with a maximum count of 4095 (base 10) is being used, then the frequency range is linear with a count range of 88. The count difference from the counter is 44 (base 10) between the nominal frequency and the minimum tuned frequency count. In this case, k₃ is 44.

The value P will either be positive or negative. If the value of P is negative, then the value needs to roll over to the maximum values of the bus. In this case, the bus is 12 bit. Then if the first term is less than k₃ by 24, then the P value would be 4096-24, or 4072 base 10.

The values given above for the variables in Equations I and II may vary with different embodiments of the present invention. The values given in the preceding examples are used for the purpose of understanding the operation of the invention, and not for the purpose of defining the scope of the invention.

With the preset P as a correction to the period count made by the counter 140, the period count maintains its accuracy even as the frequency of the voltage controlled oscillator 150 varies. In an embodiment, this allows for a measurement to be made quickly that might otherwise take a relatively long time to be made with one of the lower frequencies produced by a voltage controlled oscillator.

In the embodiment of the invention shown in FIG. 2, the period count output from the counter 140 at the output labeled “Q”, is sent to a latch 50, which is activated by the shift register 160, as described above. The latch 50 is also connected to a display 60, although in other embodiments of the present invention the latch 50 might be connected to other digital logic, such as comparators, logic gates, or other digital storage unit, such as RAM.

As shown in FIG. 2, the counter 140, N-divider 10, shift register 160, latch 50, and display 60 together constitute a period counter block 170 in an embodiment of the present invention. In other embodiments, not all of these devices may be included in the period counter block 170; for example, the display 60 might be included in a different block, and it is not necessary for the function of the present invention that it be organized in the period counter block 170.

In an embodiment of the invention, the method and system of period counting with only a voltage controlled oscillator is implemented within a field programmable gated array (FPGA) device. There may be other embodiments of the invention implemented within, for example, a digital signal processor (DSP) or in another type of programmable logic device.

It should be understood that various changes and modifications to the presently preferred embodiments described herein would be apparent to those skilled in the art. Such changes and modifications may be made without departing from the spirit and scope of the present invention and without diminishing its attendant advantages.

All references, including publications, patent applications, and patents, cited herein are hereby incorporated by reference to the same extent as if each reference were individually and specifically indicated to be incorporated by reference and were set forth in its entirety herein.

What is claimed is:

1. A period counter for measuring a device under test signal using a tunable oscillator without using an additional reference oscillator, comprising:
a digital input;
a scalar multiplier for scaling the digital input to produce a scaled digital input;
a digital-to-analog converter for converting the digital input into an analog voltage;
a tunable oscillator whereby a period of the oscillator is tunable with the analog voltage, producing a tunable oscillator signal; and
a preloadable counter, preloaded with the scaled digital input, whereby the device under test signal and the tunable oscillator signal are received and a measurement is produced.

2. The period counter of claim 1, wherein the scalar multiplier is a sequence of digital logic that inverts and multiplies the digital input to produce the scaled digital input.

3. The period counter of claim 2, wherein the scalar multiplier further includes digital logic that subtracts to produce the scaled digital input.

4. The period counter of claim 1, further comprising a divider whereby the device under test signal is divided.

5. The period counter of claim 1, further comprising a shift register for receiving the device under test signal and the tunable oscillator signal in order to produce a first shift register output and a second shift register output.

6. The period counter of claim 5, wherein the preloadable counter is preloaded after receiving the second shift register output.

7. The period counter of claim 5, further comprising a latch for latching the measurement produced by the preloadable counter after receiving the first shift register output.

8. The period counter of claim 6, further comprising a display for displaying the measurement latched with the latch.

9. The period counter of claim 1, wherein the tunable oscillator is a voltage controlled oscillator.

10. A period counter for measuring a device under test signal using a tunable oscillator without using an additional reference oscillator, comprising:
a digital input;
a scalar multiplier for scaling the digital input with a sequence of digital logic that inverts and multiplies the digital input to produce a scaled digital input;
a digital-to-analog converter for converting the digital input into an analog voltage;
a tunable oscillator, with period tunable using the analog voltage, whereby a tunable oscillator signal is produced; and
a preloadable counter, preloaded with the scaled digital input, whereby the device under test signal and the tunable oscillator signal are received and a measurement is produced.

11. The period counter of claim 10, wherein the scalar multiplier further includes digital logic that subtracts to produce the scaled digital input.

12. The period counter of claim 10, further comprising a divider whereby the device under test signal is divided.

13. The period counter of claim 10, further comprising a shift register for receiving the device under test signal and the tunable oscillator signal in order to produce a first shift register output and a second shift register output.

14. The period counter of claim 13, wherein the preloadable counter is preloaded after receiving the second shift register output.

15. The period counter of claim 13, further comprising a latch for latching the measurement produced by the preloadable counter after receiving the first shift register output.

16. The period counter of claim 15, further comprising a display for displaying the measurement latched with the latch.

17. The period counter of claim 10, wherein the tunable oscillator is a voltage controlled oscillator.

18. A period counter for measuring a device under test signal using a tunable oscillator without using an additional reference oscillator, comprising:
a digital input;
scalar multiplication means for scaling and subtracting the digital input to produce a scaled digital input;
converter means for converting the digital input into an analog voltage;
tuner means for tuning an oscillator with the analog voltage to produce an oscillator signal; and
counter means for receiving the device under test signal and the oscillator signal in order to produce a corrected measurement, the measurement being corrected by a preset preloaded onto the counter means.

19. The period counter of claim 18, further comprising divider means for diving the device under test signal.

20. The period counter of claim 18, further comprising:
shift register means for producing a first shift register output and a second shift register output; and
wherein the counter means preloads the preset after receiving the second shift register output.

21. The period counter of claim 20, further comprising latch means for latching the corrected measurement after receiving the first shift register output.

22. The period counter of claim 21, further comprising a display for displaying the corrected measurement latched with the latch means.

23. A method for period counting a device under test signal with a tunable oscillator, the method comprising the steps of:
receiving a digital input;
scaling the digital input to produce a scaled digital input;
converting the digital input to an analog voltage;
tuning the tunable oscillator with the analog voltage to produce a tunable oscillator signal;
counting the device under test signal with the tunable oscillator signal to produce a period count; and
correcting the period count with the scaled digital input.

24. The method for period counting of claim 23, wherein the step of scaling the digital input to produce a scaled digital input comprises an inverting and a multiplying.

25. The method for period counting of claim 24, wherein the step of scaling the digital input to produce a scaled digital input further comprises a subtracting.

26. The method for period counting of claim 23, further comprising the step of:
dividing the device under test signal.

27. The method for period counting of claim 23, further comprising the steps of:
receiving the device under test signal and the tunable oscillator signal;
producing a first trigger and a second trigger;
counting the device under test signal with the tunable oscillator signal to produce the period count after receiving the second trigger; and
latching the period count after receiving the first trigger to produce a latched period count.

28. The method for period counting of claim 27, further comprising the step of displaying the corrected measurement after receiving the latched period count.
